(19) United States
(12) Patent Application Publication
(10) Pub. No.: US 2012/0311166 A1
(43) Pub. Date: Dec. 6, 2012

(54) Pipe Selection Heuristics

(76) Inventors: Roberto Garcia, JR., Sunnyvale, CA (US); Yan Yang, San Jose, CA (US); Justin Mcleod North Wood, Sunnyvlae, CA (US); Jose S. Abuan, San Jose, CA (US); Hyeonkuk Jeong, Saratoga, CA (US)

(21) Appl. No.: 13/225,201

(22) Filed: Sep. 2, 2011

Related U.S. Application Data
(60) Provisional application No. 61/493,391, filed on Jun. 3, 2011.

(51) Int. Cl. G06F 15/16

(52) U.S. Cl. 709/228

(57) ABSTRACT

A method and apparatus of a device that manages connection pairs between a pair of devices is described. The device receives a metric from an application that indicates a preference to be used in suggesting a connection pair between a pair of devices. The device further receives characteristics of the connection pairs and selects one of the connection pairs based on these characteristics and the application metric. The device suggests the selected connection pair to the application.

### RELATED APPLICATIONS

Applicant claims the benefit of priority of prior, co-pending provisional application Ser. No. 61/493,391, filed Jun. 3, 2011, the entirety of which is incorporated by reference.

### FIELD OF INVENTION

This invention relates generally to data networking and more particularly to selecting data communication connections between pairs of devices.

### BACKGROUND OF THE INVENTION

Modern network connections between applications running on a pair of devices will use a socket to communicate data between these pair of devices. A socket is an endpoint in a bidirectional communication flow across a computer network. Each socket is bound to an interface of the device. An application communicates with a remote device through the socket.

If a device has multiple interfaces (e.g., a mobile device with a WiFi interface and a cellular data interface), an application will request a socket for one or more of the interfaces. However, in order to take advantage of the availability of the different interfaces, the application may use only one of the interfaces or manage the use of either or both of the interfaces. The trouble lies in that the multiple interfaces may not always be available or an optimal one for the networking characteristics an application is interested in. For example, a wireless interface may be the fastest of the available interfaces, but may not be widely available as the mobile device roams. In contrast, a cellular data interface may more widely available than the wireless interface, but may be slower than the wireless interface and more costly.

Because sockets are bound to an interface, it is difficult for an application to take advantage of the availability of the different interfaces that are available, to recover if an interface goes down, or another interface becomes available.

### SUMMARY OF THE DESCRIPTION

A method and apparatus of a device that manages connection pairs between a pair of devices is described. In an exemplary embodiment, the device receives a metric from an application that indicates a preference to be used in suggesting a connection pair between a pair of devices. The device further receives characteristics of the connection pairs and selects one of the connection pairs based on these characteristics and the application metric. The device suggests the selected connection pair to the application.

In another embodiment, a machine-readable medium has executable instructions to cause one or more processing units to perform a method of suggesting a new one of a plurality of connection pairs between a first and second device to an application based on a metric received from the application. In one embodiment, the method receives an indication that an active one of the plurality of connection pairs is disconnected. The method further evaluates a remaining one or more of the plurality of connection pairs according to the metric. In addition, the method selects one of the remaining one or more of the plurality of connection pairs based on characteristics of the remaining one or more of the plurality of connection pairs and the metric. The method also suggests that the one of the remaining one or more of the plurality of connection pairs to the application.

In a further embodiment, a machine-readable medium has executable instructions to cause one or more processing units to perform a method of processing a new connection pair between a first and second device to an application based on a metric received from the application. In one embodiment, the method receives an indication of an availability of the new connection pair, where there is an active connection pair between the first and second device for the application. The method further evaluates the new connection pair according to the metric against an active connection pair. If the new connection pair ranks higher that the active connection pair, the method suggests the new connection pair to the application.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1A is a block diagram of one embodiment of system that has multiple connection pairs between two devices.

FIG. 1B is a block diagram of one embodiment of system that has multiple connection pairs between two devices with a relay in the intervening network.

FIG. 2A (prior art) is a block diagram of one embodiment of an application layer interacting with a network layer.

FIG. 2B is a block diagram of one embodiment of an application layer interacting with a network layer through a connection management layer.

FIG. 3 is a block diagram of one embodiment of a system illustrating multiple possible connection pairs that are available between two devices with multiple network interfaces.

FIG. 4 is a flow diagram of one embodiment of a process to discover multiple connection pairs and suggest a connection pair to an application based on preferences supplied by the application.

FIG. 5 is a flow diagram of one embodiment of a process to detect a disconnection of an active connection pair and suggest a new connection pair.

FIG. 6 is a flow diagram of one embodiment of a process to handle an availability of a new connection pair.

FIG. 7 is a block diagram of one embodiment of a network connection module to manage connection pairs for an application.

FIG. 8 is a block diagram of one embodiment of an initial connection pair discovery module to discover multiple connection pairs and suggest a connection pair to an application based on preferences supplied by the application.

FIG. 9 is a block diagram of one embodiment of a dropped connection pair module to detect a disconnect of an active connection pair and suggest a new connection pair.

FIG. 10 is a block diagram of one embodiment of a new connection pair module to handle an availability of a new connection pair.

FIG. 11 illustrates one example of a typical computer system, which may be used in conjunction with the embodiments described herein.

FIG. 12 shows an example of a data processing system, which may be used with one embodiment of the present invention.

### DETAILED DESCRIPTION

A method and apparatus of a device that manages connection pairs between a pair of devices. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that manages connection pairs between a pair of devices is described. The device receives a metric from an application that indicates a preference to be used in suggesting a connection pair between a pair of devices. The device further receives characteristics of the connection pairs and selects one of the connection pairs based on these characteristics and the application metric. The device suggests the selected connection pair to the application.

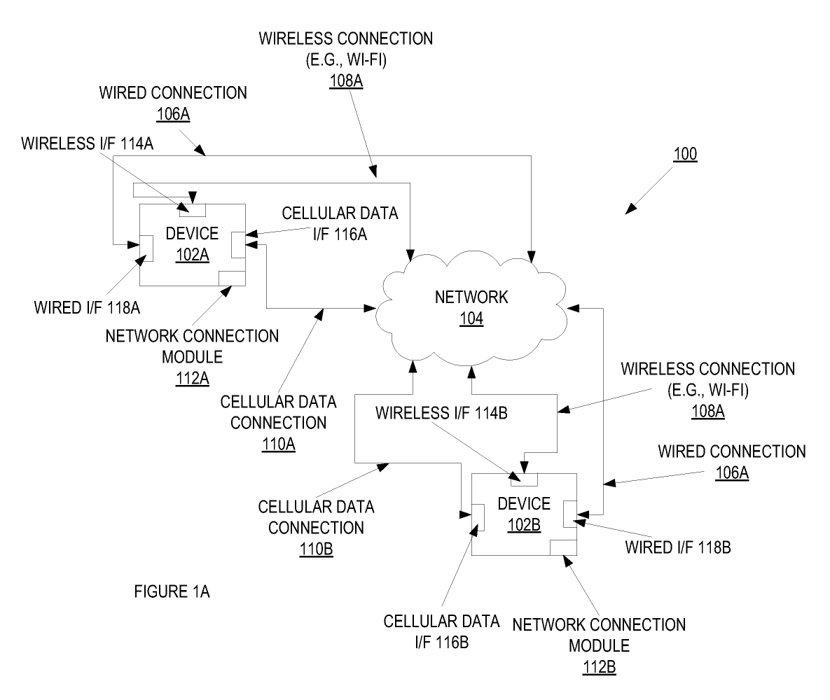

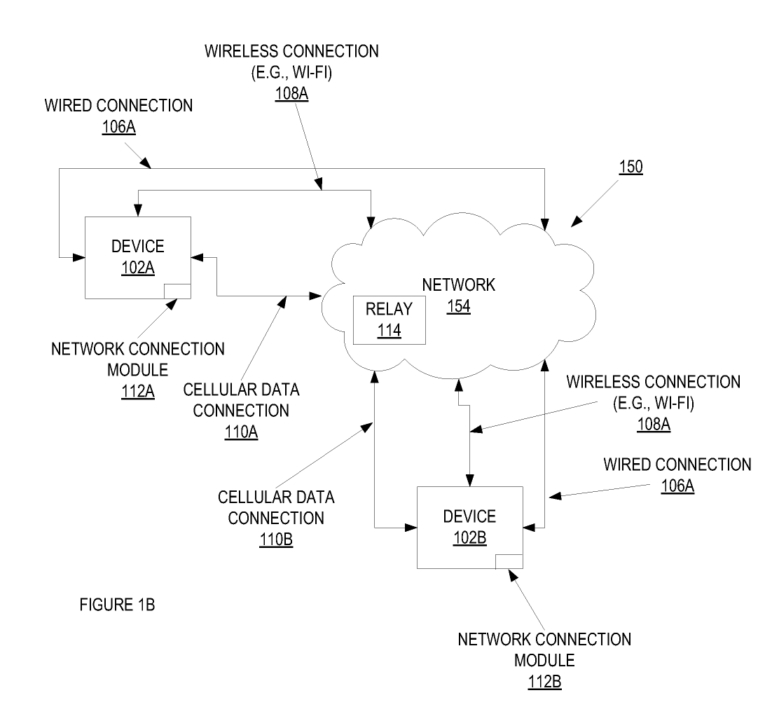

FIG. 1A is a block diagram of one embodiment of system 100 that has multiple connections between two devices. In FIG. 1A, system 100 includes devices 102A-B that are coupled via network 104. While in one embodiment, network 104 is the Internet, in alternate embodiments, network 104 is another type of network (intranet, etc., or another type of network as known in the art). Device 102 A-B can each be one of a mobile device (smartphone, laptop, personal digital assistant, gaming device, etc.), personal computer, etc., or any other device that can support multiple interfaces or communicate with another device that has multiple interfaces. In one embodiment, device 102A includes one or more different interfaces that are used to communicate data with device 102B. For example and in one embodiment, device 102A may includes wireless interface 114A (e.g., 802.11a/b/g/n, 802.16 WIMAX, etc. or other wireless interface as known in the art), cellular data interface 116A (e.g. 3G CDMA, 3G UMTA, 4G/LTE, etc. or another cellular data interface as known in the art), and/or wired interface 118A (Ethernet or another wired interface as known in the art). Similarly, device 102B may include one or more interfaces, such as wireless interface 114B, cellular data interface 116B, and/or wired interface 118B. While in one embodiment, devices 102A-B are illustrated with the same interfaces, in alternate embodiments, device 102A-B may have different number and/or type of interfaces and/or may have multiple interfaces of the same type.

Using these different interfaces, devices 102A-B can have different connections to network 104. For example and in one embodiment, devices 102A may have wired connection 106A, wireless connection 108A, and/or cellular data connection 110A. Similarly, device 102B may have wired connection 106B, wireless connection 108B, and/or cellular data connection 110B. With each device 102A-B potentially having multiple interfaces, an application running on either device 102A-B can have can be different combinations of data connections between device 102A-B to use to communicate data. For a certain class of applications (e.g., peer to peer (P2P), video calls, voice calls, etc.), these applications use pairs of connections between device 102A-B. For example and in one embodiment, as illustrated in FIG. 1A, devices 102A-B may take advantage of up to nine different connection pairs (wireless connection 108A—wired connection 106B, wireless connection 108A—wireless connection 108B, wireless connection 108A—cellular data connection 110B, cellular data connection 110A—wired connection 106B, cellular data connection 110A—wireless connection 108B, cellular data connection 110A—cellular data connection 110B, wired connection 106A—wired connection 106B, wired connection 106A—wireless connection 108B, and wired connection 106A—cellular data connection 110B). In one embodiment, each of these different connection pairs can have different advantages and disadvantages.

During a communication session, an application may be able to make use of some or all of the connection pairs. Furthermore, these connection pairs can have different characteristics and/or policies. For example and in one embodiment, a connection pair may support a higher bit rate, have better quality (e.g., low jitter, low packet delay, etc.), greater or lower cost, connection transience, data remaining on plan, user preference for service provider, etc. and/or any other characteristic of a data network as known in the art. In one embodiment, a connection pair is a pair of connections on two devices that is used to communicate data between those two devices. For example and in one embodiment, a connection pair can be a pair of sockets on the two devices. In this embodiment, there is one socket for each device participating in the connection pair. In another embodiment, the connection pair has four sockets, where there are two sockets for each device participating in the connection pair. In this embodiment, there is one socket for transmission and one for receiving for each device. In a further embodiment, there may be multiple connection pairs that an application can take advantage of. In one embodiment, a connection pair that an application is currently using is the active connection pair.

In one embodiment, each device 102A-B includes a network connections module 112A-B, respectively, that is used to manage the different connection pairs for an application that can communicate data between these devices 102A-B. In one embodiment, the network connections module 112A-B can suggest a connection pair to an application based on one or more preferences that an application indicates to the network connections module 112A-B. In one embodiment, an application preference can be bit rate, jitter or other quality measure, data communication costs, etc. and/or another metric that can be used to characterize data communication. For example and in one embodiment, a video call application may indicate a preference of using the connection with the highest available bit rate or lowest jitter. In this embodiment, network connections module 112A-B would rank the available connection pairs for bit rate, jitter, or other preference that an application indicated as being important. In another embodiment, an application can indicate multiple preferences for a connection pair. For example and in one embodiment, an application may indicate that it would prefer a connection pair that has a high bit rate at a low data cost.

In another embodiment, network connections module 112A-B discovers new connections pair(s) that become available for an application. In one embodiment, the network connections module 112A-B rank new connection pair(s) against other known connection pairs. If a new connection pair ranks higher than an active connection pair for an application, the network connections module 112A-B may suggest the newly discovered connection pair to the application. If the application starts to use the newly discovered connection pair, the network connections module 112A-B stores that the active connection pair for the application as the newly discovered connection pair. Furthermore, network connections module 112A-B informs the remote device to use the corresponding connection of the active connection pair. For example and in one embodiment, if an application on device 102A chooses wireless connection 108A—cellular data connection 110B as the active connection pair, network connection module 112A informs the network connection module 112B a corresponding application on device 102B that is communicating with the application to use cellular data connection 110B as the connection for the corresponding application on device 102B to communicate with the application on device 102A.

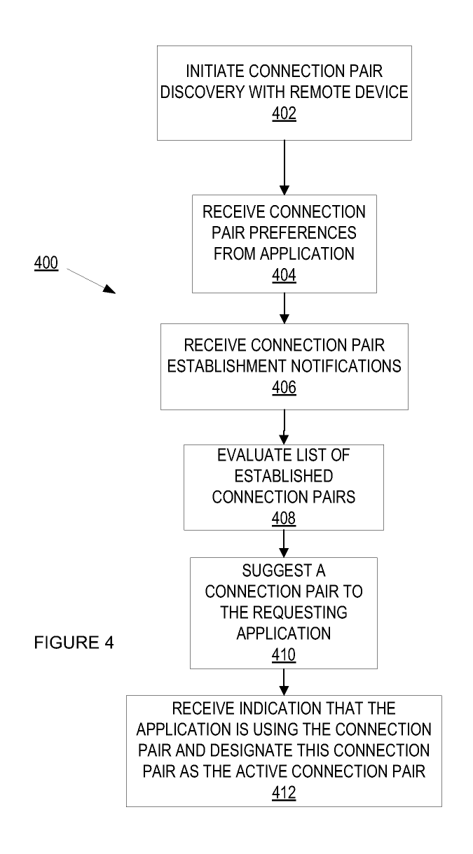

In a further embodiment, if an active connection pair becomes disconnected and the application cannot use this connection pair for communicating data, the network connections module 112A-B may re-rank known connection pairs for the application and suggest a new connection pair for the application to use. The management of connection pairs for an application is further described in FIGS. 4-6 below.

In one embodiment, an application can take advantage of a relay to relay data between the devices. In one embodiment, a relay is a server or that is capable of transmitting packets on behalf of one endpoint to a different endpoint over the Internet. For example and in one embodiment, relay is a relay implementing Internet Engineering Task Force (IETF) Draft 5766 relay protocol. FIG. 1B is a block diagram of one embodiment of system 150 that has multiple connections between two devices with a relay in the intervening network 154. In FIG. 1A, system 150 includes devices 102A-B that are coupled via network 104. Unlike in FIG. 1A, network 154 includes relay 114.

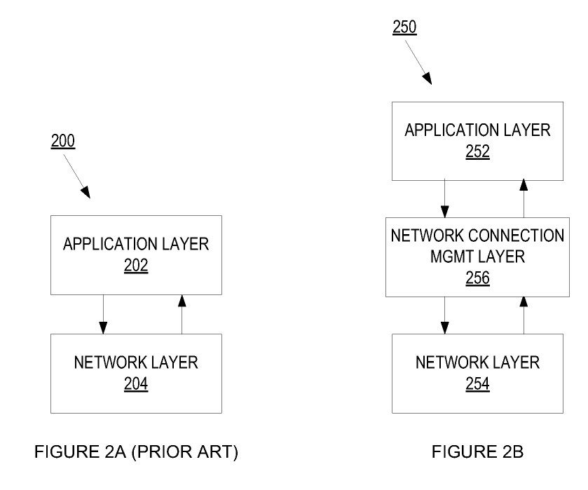

FIG. 2A (prior art) is a block diagram of one embodiment of an application layer 202 interacting with a network layer 204. In FIG. 2A, system 200 illustrates application layer 202 interacting with a network layer so that an application may communicate with a remote device. In this embodiment, application layer 202 requests a socket from the network layer 204 for one of the device's interface. The network layer 204 returns the socket to the application layer 202 for that interface. As described above, the problem for the application layer 202 is that it is up to the application layer 202 to manage discovery, disconnection, and evaluation of possible connection pairs.

FIG. 2B is a block diagram of one embodiment of an application layer 252 interacting with a network layer 254 through a connection management layer. In FIG. 2A, network connection management layer 256 manages connection pairs for the application layer 252. In one embodiment, network connection management 256 makes calls to network layer 254 to create sockets to be used for connection pairs for the application layer 252. For example and in one embodiment, the network connection management 254 returns a single connection pair-source socket and destination address, along with notifications for when properties of the connection change. Furthermore, network connection management layer 256 manages the existing connection pairs for the application layer. In one embodiment, network connection management layer 256 determines if connection pairs are connected, discovers new connection pairs, and evaluates the new and existing connection pairs. For example and in one embodiment, network connection management layer 256 determines if a connection pair is connected by transmitting and receiving keep alive packets. For example and in one embodiment, the network connection management layer will enforce an ordering of which pairs are to be used based on feedback from the application. In another embodiment, the network management layer 254 may collect statistics of the connection pair in order to refine the ordering.

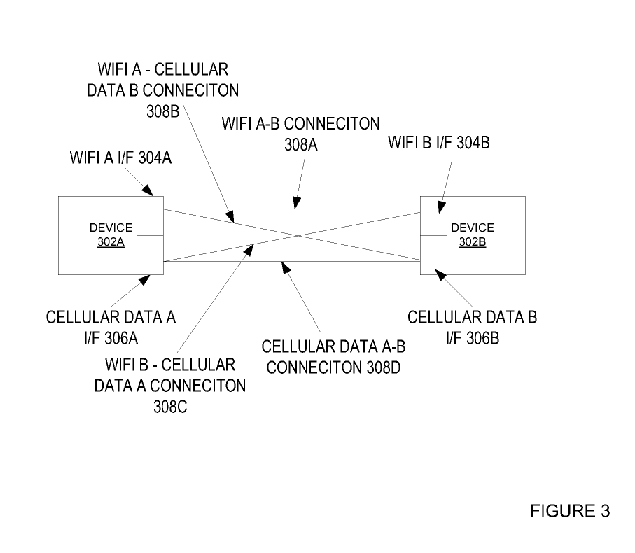

FIG. 3 is a block diagram of one embodiment of a system 300 illustrating multiple possible connections that are available between two devices with multiple network interfaces. In FIG. 3, devices 302A-B have a WiFi interface and a cellular data interface. Although in this embodiment, each of the devices 302A-B are illustrated with two of the same interfaces, in alternate embodiments, the devices 302A-B may have different, less and/or more interfaces that can be used communicating data with the other device. For example and in one embodiment device 302A includes wireless A interface 304A, and cellular data A 306A, and device 302B includes wireless B interface 304B, and cellular data B 306B. In one embodiment, between devices 302A-B, there can be up to four connection pairs: WiFi A-B connection pair 308A, WiFi A—cellular data B connection pair 308B, WiFi B—cellular data C connection pair 308C, and cellular data A-B connection pair 308D. In one embodiment, each of these connection pairs 308A-D may have various advantages and/or disadvantages. For example and in one embodiment of WiFi A-B connection pair 308A may have the fastest the highest bit rate for which to communicate data between the two devices, but this connection 308A does not allow either device to roam far form the wireless access point each of the devices is using to communicate data. As another example, cellular data A-B connection 308A-B may allow greater roaming of devices 302A-B, but this connection pair may have a lower bit rate and further cost greater than some or all of the other connection pairs 308A-C. In one embodiment, mix connection pairs, for example, WiFi A—cellular data B connection pair 308B and WiFi B—cellular data B connection pair 308C allow one of the device greater mobility. In one embodiment, a connection pair is a pair of connections on two devices that is used to communicate data between those two devices. For example and in one embodiment, a connection pair can be a pair of sockets on the two devices. In addition, there may be multiple connection pairs that an application can take advantage of.

FIG. 4 is a flow diagram of one embodiment of a process 400 to discover multiple network connections and suggest a connection pair to an application based on preferences supplied by the application. In FIG. 4, process 400 begins by initiating a network connection discovery with a remote device a block 402. In one embodiment the network connection discovery of process 400 is performed by communicating with the remote device to understand which interface the remote device has available for creating connection pairs and further, transmit interfaces to that remote device that are available on the device running process 400. For example and in one embodiment, process 400 may discover for different interfaces available for connection pairs corresponding to two different interfaces on each device used in the communication as illustrated in FIG. 3 above. In one embodiment, process 400 uses a protocol Internet Connectivity Establishment (ICE) transaction as known in the art to discover these connection pairs available between two devices.

At block 404, process 400 receives one or more connection preferences from an application that process 400 will use to manage the different connection pairs for the application. In one embodiment, an application preference can be bit rate, jitter or other quality measure, data communication costs, etc. and/or another metric that can be used to characterize data communication. In one embodiment, the application is peer-to-peer type application that can take advantage of using different connection pairs to maintain that data communication over time period used for this data communication. For example and in one embodiment, the application can be a peer-to-peer file sharing application, a video call type of application, a voice type voice call type of application, etc., and/or any other type of application known in the art at has a peer-to-peer type of architecture. An alternate embodiment application can be a client/server type of application, in which the client is a mobile client that can roam and use different interfaces during the roaming.

At block 406, process 400 receives network connection pair establishment notifications. In one embodiment, the network connection establishment notifications are used to notify to process 400 that one or more of a connection pairs are available to process 400. In one embodiment, process 400 uses on an out-of-band communication the connection candidates (that will be used form connection pairs) to the remote device. For example and in one embodiment, process 400 uses the communication system as described in U.S. patent application Ser. No. 12/832,015, entitled “APPARATUS AND METHOD FOR MATCHING USERS FOR ONLINE SESSIONS,” filed on Jul. 7, 2010 and incorporated by reference herein. In another embodiment, if there is an active connection pair in existence between the devices, process 400 can collect and exchange new candidate connection pair over the active connection pair and a check using the ICE protocol may be performed in order to establish these new pairs.

At block 408, process 400 evaluates the list of established network connection pairs available against the connection preferences received from application. For example and in one embodiment, if the application preference is bit rate, process 400 would determine which connection pair has the highest bit rate. In one embodiment, process 400 estimates the bit rate by assuming a certain bitrate capability depending on the interface type or by actively probing the connection pair.

At block 410, process 400 suggests a network connection pair to the requesting application. For example and in one embodiment, and referring to FIG. 3, if WiFi A-B 308A connection pair is the connection pair with the highest bit rate and the application has indicated a connection preference using the highest bit rate connection pair, process 400 would suggest to use the WiFi A-B 308 A connection pair. In another embodiment, if the application indicates to process 400 that connection pair with the least cost and is one that is not entirely based on a cellular data connection, process 400 would suggest one of the WiFi based connection pairs (e.g., connection pairs 308A-C as illustrated in FIG. 3 above). In one embodiment, process 400 suggests the connection pair by communicating the socket information to the application.

At block 412, process 400 receives an indication that the requesting application is using the connection pair and further, process 400 stores that connection pair is the active connection pair for the application. In addition, process 400 informs the application of the remote device in the active connection pair to use connection for that device in the active connection pair.

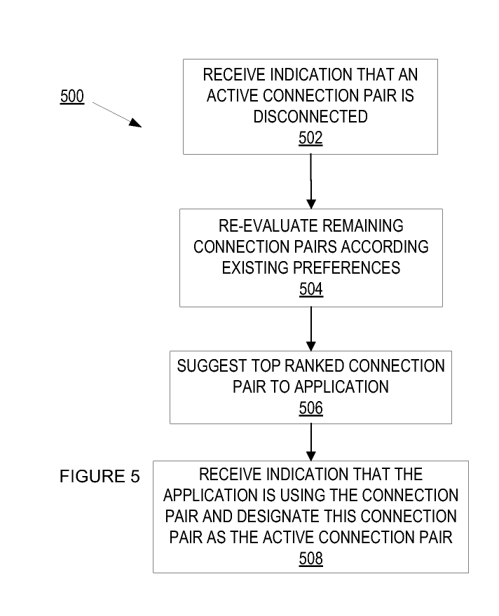

As described above, the network connection module 112A-B can further manage connection pairs for an application. For example and in one embodiment, the network connection module 112A-B can handle a disconnection of an active connection pair and possibly suggest this new connection pair to the application. FIG. 5 is a flow diagram of one embodiment of a process to detect a disconnection of an active connection pair and suggest a new connection pair. In FIG. 5, process 500 begins by receiving an indication that an active connection pair is disconnected at block 502. In one embodiment pair, a connection pair can be disconnected if one or more of interfaces in that connection pair is no longer is able to communicate data across that interface. For example and in one embodiment, an application is using a Wi-Fi in a Wi-Fi-based connection pair and one of the devices in this connection pair of roams outside of the active WiFi connection area. This would cause that Wi-Fi interface to longer be able to communicate data and that connection pair would be disconnected. Alternatively, an intervening link in the connection pair may not be available, causing the connection pair to be disconnected.

At block 504, process 500 reevaluates the remaining connection pairs according to the existing preference of the application. In one embodiment, process 500 retrieves the preferences for that application and compares it with the known characteristics of the remaining active connection pairs. For example and in one embodiment, WiFi A-B 308A connection has been disconnected and application indicates that it prefers a connection pair with a high bit rate. In this embodiment, process 500 determines which of the existing connection pairs has the highest bit rate. Process 500 suggests a new connection pair to the application at block 506. At block 508, process 500 receives an indication that the requesting application is using the connection pair and further, process 500 stores that connection pair is the active connection pair for the application. In addition, process 500 informs the application of the remote device in the active connection pair to use connection for that device in the active connection pair.

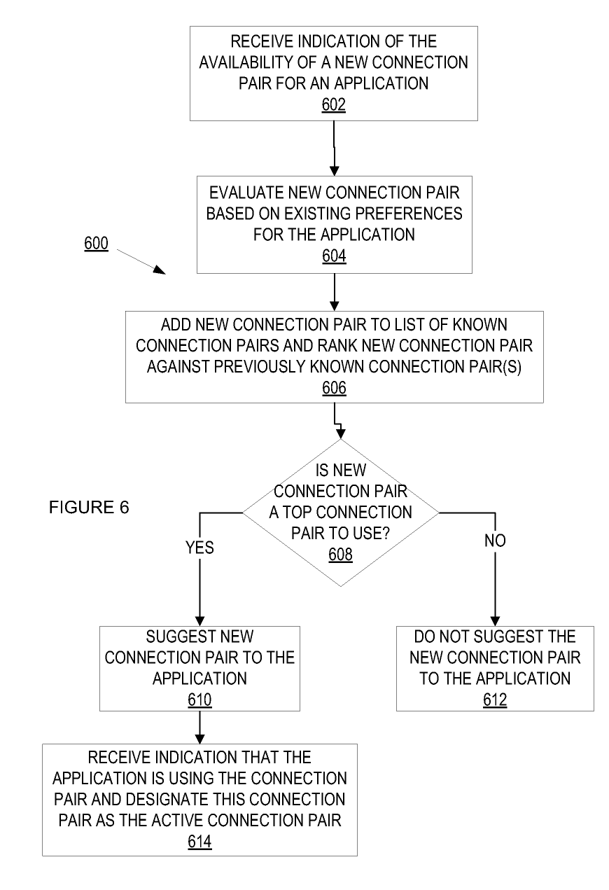

As described above, the network connection module 112A-B can discover new connection pairs for an application has an active connection pair and possibly suggest this new connection pair to the application. FIG. 6 is a flow diagram of one embodiment of a process 600 to handle an availability of a new connection pair. In FIG. 6, process 600 begins by receiving an indication of an availability of a new connection pair for an application at block 602. In one embodiment, process 600 receives hint that the existing connection pair used is not adequate for its purpose. In this embodiment, process 600 will re-check the existing connection pairs, change the underlying connection pair, inform the application that the properties of the underling connection pair have changed. For example and in one embodiment, process 600 receives an indication availability of WiFi connection pair as the device process 600 is running on couples with and connects to a Wi-Fi network. In this example, process 600 would receive an indication of the availability of a connection pair involving the WiFi interface.

At block 604, process 600 evaluates the new discovered connection pair based on existing preferences for the application. In one embodiment, process 600 retrieves the one or more stored preferences for an application and uses this to evaluate the new connection pair. At block 606, process 600 evaluates the new connection pair and ranks the new connection pair against these previously known connection pairs. In one embodiment, process 600 uses the stored preference to evaluate the new connection pair using a metric for that connection pair. For example and in one embodiment, process 600 measures the bit rate jitter of the new connection pair or other characteristics based on the preferences for that application.

At block 608, process 600 determines if this new connection pair is a top connection pair to use for an application. If this connection pair is a top connection pair, at block 610, process 600 suggests the new connection pair to the application. At block 614, process 600 receives an indication that the requesting application is using the new connection pair and further, process 600 stores that this new connection pair is the active connection pair for the application. If process 600 determines that the new connection pair is not a top connection pair, at block 612, process 600 does not suggest the new connection pair to the application. Instead, process 600 adds the new connection pair to the list of known connection pairs for the application. In addition, process 500 informs the application of the remote device in the active connection pair to use connection for that device in the active connection pair.

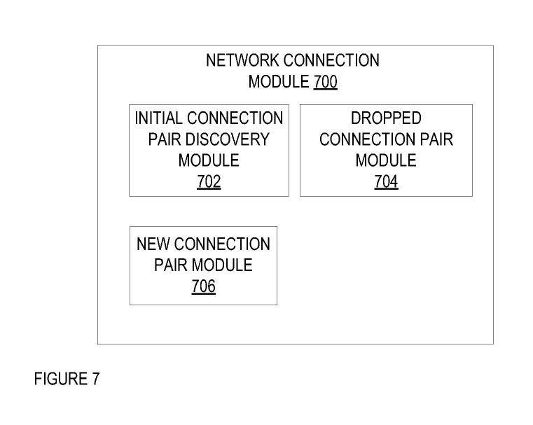

FIG. 7 is a block diagram of one embodiment of a network connection module 700 to manage connection pairs for an application. In one embodiment, network connection module 700 is the network connection module 112A-B as described in FIGS. 1AB above. In one embodiment, network connection module 700 comprises initial connection pair discovery module 702, dropped connection pair module 704, and new connection pair module 706. Initial connection pair discovery module 702 performs the initial discovery and connection pair suggestion for a device as described in FIG. 4 above. Dropped connection pair module 704 manages a dropped active connection pair as described in FIG. 5 above. New connection pair module 706 manages the discovery of a new connection pair as described in FIG. 6 above.

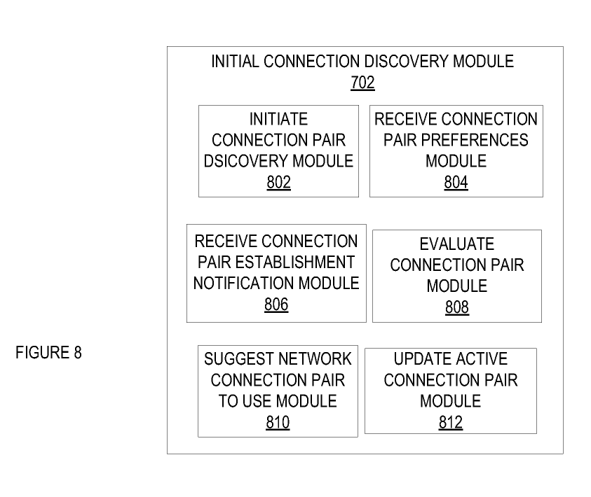

FIG. 8 is a block diagram of one embodiment of an initial connection pair discovery module 702 to discover multiple connections pairs and suggest a connection pair to an application based on preferences supplied by the application. In one embodiment, initial connection pair discovery module 702 comprises initiate connection pair discovery module 802, receive connection pair preferences module 804, received connection pair establishment notification module 806, evaluate connection pair module 808, suggest connection pair to use module 810, and update active connection pair module 812. Initiate connection pair discovery module 802 initiates the discovery of connection pairs as described in FIG. 4, block 402 above. Receive connection pair preferences module 804 receives the connection pair preferences from the application as described in FIG. 4, block 404 above. Received connection pair establishment notification module 806 receives the connection pair establishment notifications as described in FIG. 4, block 406 above. Evaluate connection pair module 808 evaluates the connection pairs as described in FIG. 4, block 408 above. Suggest connection pair to use module 810 suggests a connection pair as described in FIG. 4, block 410 above. Update active connection pair module 812 updates the active connection pair as described in FIG. 4, block 412 above.

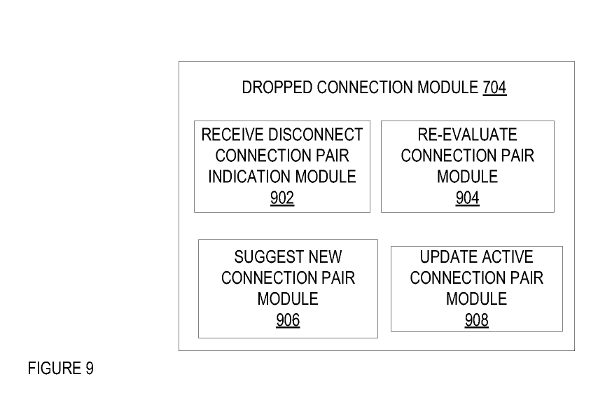

FIG. 9 is a block diagram of one embodiment of a dropped connection module 704 to detect a disconnection of an active connection pair and suggest a new connection pair. In one embodiment, dropped connection pair module comprises receive disconnect connection pair indication 902, reevaluate connection pair module 904, suggest new connection pair module 906, and update active connection pair module 908. Receive disconnect connection pair indication 902 receives an indication of a disconnect of an active connection pair as described in FIG. 5, block 502 above. Reevaluate connection pair module 904 reevaluates remaining connection pairs as described in FIG. 5, block 504 above. Suggest new connection pair module 906 suggests a new connection pair as described in FIG. 5, block 506 above. Update active connection pair module 908 updates the active connection pair as described in FIG. 5, block 508 above.

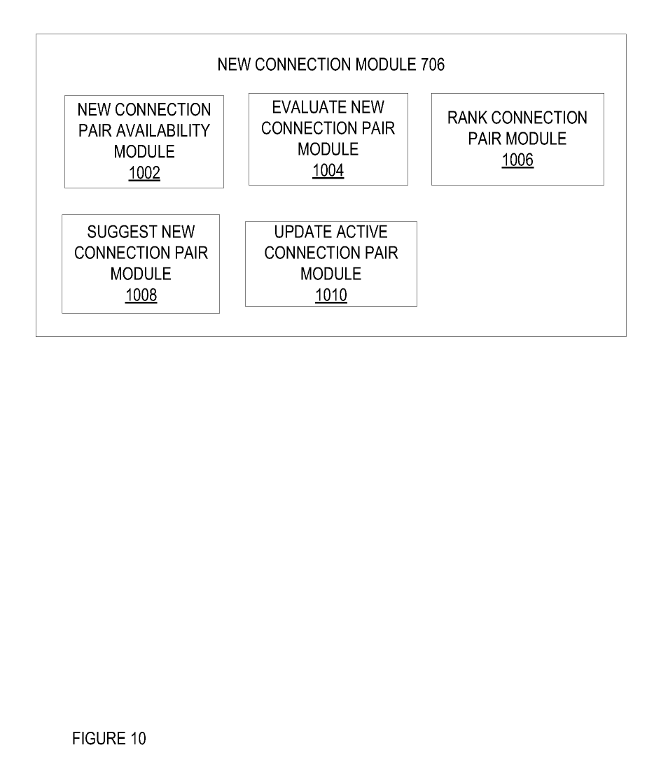

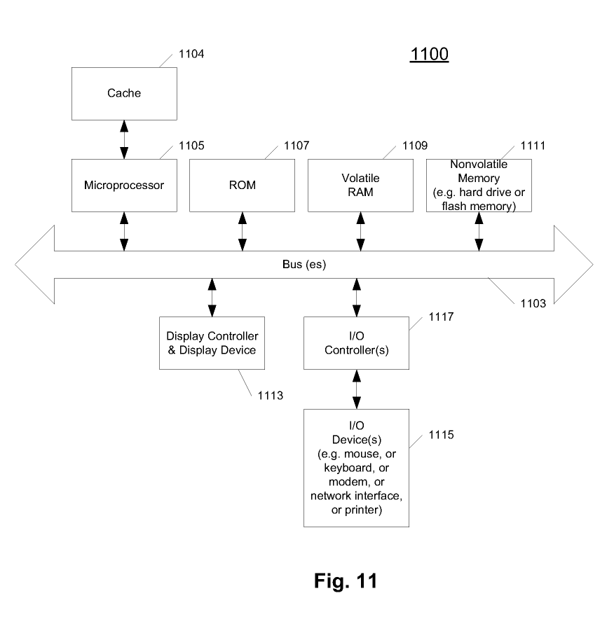

FIG. 10 is a block diagram of one embodiment of a new connection pair module 706 to handle an availability of a new connection pair. New connection pair module 706 comprises new connection pair availability module 1002, evaluate new connection pair module 1004, rank connection pair module 1006, suggest new connection pair module 1008, and update active connection pair module 1010. New connection pair availability module 1002 receives indication of a new connection pair as described in FIG. 6, block 602 above. Evaluate new connection pair module 1004 evaluates the new connection pair as described in FIG. 6, block 604 above. Rank connection pair module 1006 ranks the new connection pair as described in FIG. 6, block 606 above. Suggest new connection pair module 1008 suggests the new connection pair as described in FIG. 6, block 610 above. Update active connection pair module 1010 updates the new connection pair as described in FIG. 6, block 612 above.

FIG. 11 is a block diagram of one embodiment of a receive packet module 154 to process received packets. In one embodiment, receive packet module 154 includes receive packet on interface module 1102, find reachability record module 1104, and record current uptime module 1106. In one embodiment, receive packet on interface module 1102 receives packet on an interface as described with reference to FIG. 5, block 502 above. In one embodiment, find reachability record module 1104 finds a reachability record as described with reference to FIG. 5, block 504 above. In one embodiment, record current uptime module 1106 records a current uptime as described with reference to FIG. 5, block 508 above.

FIG. 11 shows one example of a data processing system 1100, which may be used with one embodiment of the present invention. For example, the system 1100 may be implemented including a device 102A-B as shown in FIG. 1. Note that while FIG. 11 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 11, the computer system 1100, which is a form of a data processing system, includes a bus 1103 which is coupled to a microprocessor(s) 1105 and a ROM (Read Only Memory) 1107 and volatile RAM 1109 and a non-volatile memory 1111. The microprocessor 1105 may retrieve the instructions from the memories 1107, 1109, 1111 and execute the instructions to perform operations described above. The bus 1103 interconnects these various components together and also interconnects these components 1105, 1107, 1109, and 1111 to a display controller and display device 1113 and to peripheral devices such as input/output (I/O) devices which may be mice, keyboards, modems, network interfaces, printers and other devices which are well known in the art. Typically, the input/output devices 1115 are coupled to the system through input/output controllers 1117. The volatile RAM (Random Access Memory) 1109 is typically implemented as dynamic RAM (DRAM), which requires power continually in order to refresh or maintain the data in the memory.

The mass storage 1111 is typically a magnetic hard drive or a magnetic optical drive or an optical drive or a DVD RAM or a flash memory or other types of memory systems, which maintain data (e.g. large amounts of data) even after power is removed from the system. Typically, the mass storage 1111 will also be a random access memory although this is not required. While FIG. 11 shows that the mass storage 1111 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 1103 may include one or more buses connected to each other through various bridges, controllers and/or adapters as is well known in the art.

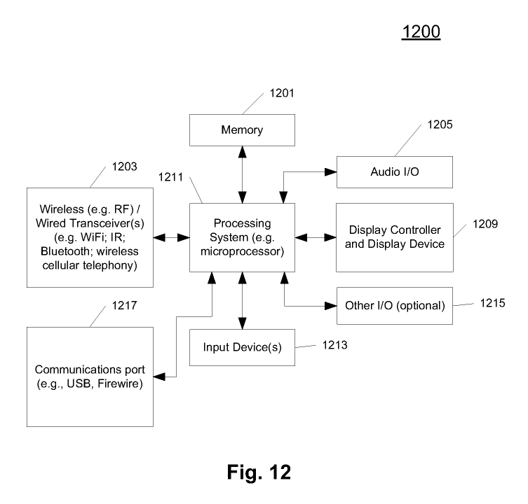

FIG. 12 shows an example of another data processing system 1200 which may be used with one embodiment of the present invention. For example, system 1200 may be implemented as a device 102A-B as shown in FIG. 1. The data processing system 1200 shown in FIG. 12 includes a processing system 1211, which may be one or more microprocessors, or which may be a system on a chip integrated circuit, and the system also includes memory 1201 for storing data and programs for execution by the processing system. The system 1200 also includes an audio input/output subsystem 1205, which may include a microphone and a speaker for, for example, playing back music or providing telephone functionality through the speaker and microphone.

A display controller and display device 1209 provide a visual user interface for the user; this digital interface may include a graphical user interface which is similar to that shown on a Macintosh computer when running OS X operating system software, or Apple iPhone when running the iOS operating system, etc. The system 1200 also includes one or more wireless transceivers 1203 to communicate with another data processing system, such as the system 1200 of FIG. 12. A wireless transceiver may be a WLAN transceiver, an infrared transceiver, a Bluetooth transceiver, and/or a wireless cellular telephony transceiver. It will be appreciated that additional components, not shown, may also be part of the system 1200 in certain embodiments, and in certain embodiments fewer components than shown in FIG. 12 may also be used in a data processing system. The system 1200 further includes one or more communications ports 1217 to communicate with another data processing system, such as the system 1500 of FIG. 15. The communications port may be a USB port, Firewire port, Bluetooth interface, etc.

The data processing system 1200 also includes one or more input devices 1213, which are provided to allow a user to provide input to the system. These input devices may be a keypad or a keyboard or a touch panel or a multi touch panel. The data processing system 1200 also includes an optional input/output device 1215 which may be a connector for a dock. It will be appreciated that one or more buses, not shown, may be used to interconnect the various components as is well known in the art. The data processing system shown in FIG. 12 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device or an embedded device or other consumer electronic devices. In other embodiments, the data processing system 1200 may be a network computer or an embedded processing device within another device, or other types of data processing systems, which have fewer components or perhaps more components than that shown in FIG. 12.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple, Inc. of Cupertino, Calif., a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. Pat. No. 7,345,671 and U.S. published patent number 2004/0224638, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “selecting,” “transmitting,” “determining,” “suggesting,” “evaluating,” “marking,” “initiating,” “adding,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method of suggesting a connection pair between a first and second device to an application based on a metric received from the application, the method comprising:
receiving, from the application, the metric indicating a preference to be used in selecting one of a plurality of connection pairs between the first and second devices;
receiving characteristics of the plurality of connection pairs;
selecting the one of the plurality of connection pairs based on the characteristics and the metric; and
suggesting the one of the plurality of connection pairs to the application.

2. The non-transitory machine-readable medium of claim 1, wherein a connection pair is a network connection through a network interface of the first to the second device.

3. The non-transitory machine-readable medium of claim 1, wherein the network interface is selected from the group consisting of a wireless interface, cellular data interface, and wired interface.

4. The non-transitory machine-readable medium of claim 1, wherein each characteristic of the characteristics is selected from the group consisting of bit rate, quality, cost, connection transience, data availability, and service provider preference.

5. The non-transitory machine-readable medium of claim 1, wherein the metric is a measurement of one or more of the characteristics.

6. The non-transitory machine-readable medium of claim 1, further comprising:
receiving an indication that the application is using the suggested connection pair.

7. The non-transitory machine-readable medium of claim 1, further comprising:
initiating a connection pair discovery between the first and second device.

8. A non-transitory machine-readable medium having executable instructions to cause one or more processing units to perform a method of suggesting a new one of a plurality of connection pairs between a first and second device to an application based on a metric received from the application, the method comprising:
receiving an indication that an active one of the plurality of connection pairs is disconnected;
evaluating a remaining one or more of the plurality of connection pairs according to the metric;
selecting one of the remaining one or more of the plurality of connection pairs based on characteristics of the remaining one or more of the plurality of connection pairs and the metric; and
suggesting the one of the remaining one or more of the plurality of connection pairs to the application.

9. The non-transitory machine-readable medium of claim 8, further comprising:
receiving an indication that the application is using the one of the remaining one or more of the plurality of connection pairs.

10. The non-transitory machine-readable medium of claim 8, further comprising:
marking the one of the remaining one or more of the plurality of connection pairs as the active connection pair for the application.

11. The non-transitory machine-readable medium of claim 8, wherein a connection pair is a network connection through a network interface of the first to the second device.

12. The non-transitory machine-readable medium of claim 11, wherein the network interface is selected from the group consisting of a wireless interface, cellular data interface, and wired interface.

13. The non-transitory machine-readable medium of claim 8, wherein each characteristic of the characteristics is selected from the group consisting of bit rate, quality, cost, connection transience, data availability, and service provider preference.

14. The non-transitory machine-readable medium of claim 8, wherein the existing preference is a measurement of one or more of the characteristics.

15. A non-transitory machine-readable medium having executable instructions to cause one or more processing units to perform a method of processing a new connection pair between a first and second device to an application based on a metric received from the application, the method comprising:
receiving an indication of an availability of the new connection pair, wherein there is an active connection pair between the first and second device for the application;
evaluating the new connection pair according to the metric against an active connection pair;
if the new connection pair ranks higher that the active connection pair, suggesting the new connection pair to the application.

16. The non-transitory machine-readable medium of claim 15, further comprising:
receiving an indication that the application is using the new connection pair.

17. The non-transitory machine-readable medium of claim 15, further comprising:
marking the new connection pair as the active connection pair for the application.

18. The non-transitory machine-readable medium of claim 15, further comprising:
adding the new connection pair to a list of known connection pairs for the application.

19. The non-transitory machine-readable medium of claim 15, wherein a connection pair is a network connection through a network interface of the first to the second device.

20. The non-transitory machine-readable medium of claim 19, wherein the network interface is selected from the group consisting of a wireless interface, cellular data interface, and wired interface.
